(19) United States
(12) Patent Application Publication
(10) Pub. No.: US 2023/0350973 A1
(43) Pub. Date: Nov. 2, 2023

(54) Methods and Systems for Multilinear Discriminant Analysis Via Invariant Theory for Data Classification

(71) Applicant: REGENTS OF THE UNIVERSITY OF MICHIGAN, Ann Arbor, MI (US)

(72) Inventors: Kayvan Najarian, Northville, MI (US); Olivia Pifer Alge, Ann Arbor, MI (US); Jonathan Gryak, West Haven, CT (US); Harm Derksen, Boston, MA (US); Cristian Minoccheri, Ann Arbor, MI (US)

(21) Appl. No.: 18/139,709

(22) Filed: Apr. 26, 2023

Related U.S. Application Data
(60) Provisional application No. 63/335,546, filed on Apr. 27, 2022.

(51) Int. Cl. G06F 17/11

(52) U.S. Cl. CPC G06F 17/11

(57) ABSTRACT

Methods and systems for identifying and classifying multilinear data sets into a plurality of classes using invariant theory are disclosed herein. An example method includes receiving an input data set; computing a change of coordinates for each mode of the plurality of modes for the input data set using an invariant theory optimization algorithm by (i) constructing a chosen group and (ii) determining a group element in the chosen group; transforming the input data set into a relocated data set by applying each change of coordinates for each respective mode of the plurality of modes for the input data set by multiplying the subset of the input data set for each mode by the at least one matrix corresponding to each respective mode; and classifying, based on distances between coordinates in the relocated data set, the input data set into the plurality of classes.

### CROSS-REFERENCE TO RELATED APPLICATION

This application claims priority to and the benefit of the filing date of provisional U.S. Patent Application No. 63/335,546 entitled “METHODS AND SYSTEMS FOR MULTILINEAR DISCRIMINANT ANALYSIS VIA INVARIANT THEORY FOR DATA CLASSIFICATION,” filed on Apr. 27, 2022, the disclosure of which is expressly incorporated herein by reference in its entirety.

### GOVERNMENT LICENSE RIGHTS

This invention was made with government support under federal grant number 1837985 awarded by the National Science Foundation (NSF). The government has certain rights in the invention.

### FIELD OF THE DISCLOSURE

The present disclosure generally relates to classification of higher order data sets and, more particularly, to receiving multilinear data sets and classifying the data sets using invariant theory transformation.

### BACKGROUND

Data sets, such as tensors, often have higher order structures, and leveraging the structures of such higher order data sets improves the results of any calculation or problem-solving technique using said data sets. However, current machine learning techniques do not naturally extend to tensors in a way that properly accounts for and makes use of the higher order structure. Linear Discriminant Analysis (LDA), for example, is a classical and versatile method for classification of vectors, but is not typically well-suited for data in matrix form or in tensor form. Instead, techniques such as LDA require a system and/or user to vectorize the data first, which often leads to vectors that are large and/or difficult to analyze. Further, vectorization often causes the loss of important information, like spatial locality, reducing the accuracy of the analysis. As such, there is need for techniques to quickly and accurately analyze and classify higher order data sets, such as tensors.

### SUMMARY

In one embodiment, a method for identifying and classifying multilinear data sets into a plurality of classes using invariant theory may be provided. The method may be implemented via one or more local or remote processors, servers, sensors, transceivers, memory units, and/or other electronic or electrical components. The method includes: receiving, by one or more processors, an input data set, wherein the input data set is a multilinear input data set and includes a plurality of modes, each mode representative of a different subset of the input data set; computing, by the one or more processors, a change of coordinates for each mode of the plurality of modes for the input data set using an invariant theory optimization algorithm, wherein the computing includes: constructing a chosen group, wherein the group is a direct product of a plurality of linear groups and each linear group is independently chosen from a first set of matrices or a second set of matrices; determining a group element in the chosen group, wherein the group element comprises at least one matrix corresponding to each respective mode of the plurality of modes such that a norm of the input data under a group action induced by the group element is a local minimum; and calculating the change of coordinates based on the at least one matrix corresponding to each respective mode; transforming, by the one or more processors, the input data set into a relocated data set by applying each change of coordinates for each respective mode of the plurality of modes for the input data set by multiplying the subset of the input data set for each mode by the at least one matrix corresponding to each respective mode; and classifying, by the one or more processors and based on distances between coordinates in the relocated data set, the input data set into the plurality of classes.

In a variation of this embodiment, receiving training data for each class of the plurality of classes; and classifying the input data set further based on the training data for each class of the plurality of classes.

In another variation of this embodiment, the chosen group is a product group G, and: the training data is

$${\{ 𝒳 {m}_{i} \}}_{i} {=}^{{N}_{m}} 1$$

for each class

$$𝒳 {m}_{m} {=}^{n} 1 ,$$

where n is the number of classes, χₘ_{ᵢ} is the ith entry in a set, and there are Nₘ entries in a set for χₘ; and dᵢ=∥(Aᵢ, Bᵢ, . . . , Ωᵢ) (ζ−χ̅)∥, where ζ is the input data set, (Aᵢ, Bᵢ, . . . , Ωᵢ) is the group element of the product group G comprising the at least one matrix for each respective mode, and

$$\overline{𝒳} = \frac{1}{{N}_{m}} ( {\sum }_{i = 1}^{{N}_{m}} 𝒳 {m}_{i} ) .$$

In yet another variation of this embodiment, wherein ζ is classified as belonging to class k when dₖ=min(dᵢ).

In still yet another variation of this embodiment, the method further comprises: determining a similarity score for each class of the plurality of classes based on the training data; and classifying the input data set further based on the similarity score for each class of the plurality of classes; wherein the similarity score is defined as

$${s}_{i} = 1 - \frac{{d}_{i}}{{\sum }_{j = 1}^{n} {d}_{j}} .$$

In a variation of this embodiment, determining the group element includes: iteratively fixing each matrix of the at least one matrix except one matrix of the at least one matrix; and determining the one matrix such that the norm of the input data under the group action is a local minimum when each other matrix is fixed.

In another variation of this embodiment, the iterative fixing and determining repeats until a change in local minimum is less than a predetermined tolerance value.

In yet another variation of this embodiment, the iterative fixing and determining repeats until a predetermined number of iterations have occurred.

In still yet another variation of this embodiment, the relocated data set has a same tensor rank as the input data set.

In a variation of this embodiment, each matrix of the at least one matrix is an invertible matrix with a determinant of 1.

In another variation of this embodiment, the invariant theory optimization algorithm is an algorithm in accordance with Kempf-Ness theory.

In yet another variation of this embodiment, the distances between coordinates are Mahalanobis distances.

In still yet another variation of this embodiment, the input data set is a tensor of electrocardiogram (ECG) signals and one or more features of the ECG signals are classified.

In a variation of this embodiment, the plurality of classes are determined based on at least one of: heartbeat classification, T-wave alternans detection, and/or changes in heartbeat morphology.

In another variation of this embodiment, the input data set comprises either of: canonical polyadic decomposition (CPD) based data or higher order singular value decomposition (HOSVD) based data.

In yet another variation of this embodiment, the input data set is data in a format of at least one of: video data, facial recognition data, hyper-spectral image data, multi-lead signal data, and/or higher-order statistic data.

In still yet another variation of this embodiment, receiving the input data set includes: receiving raw data, and transforming the raw data into the input data set using a tensorization approximation.

In a variation of this embodiment, the raw data is a multi-lead ECG signal for a patient and wherein transforming the raw data into the input data set using a tensorization approximation includes: splitting the multi-lead ECG signal into one or more split signals; removing noise from the split signals using a filter; applying the tensorization approximation to each lead of the denoised signals using a predetermined number of fixed parameter values; extracting, after applying the tensorization approximation, a plurality of features from each lead; outputting a tensor for each of the denoised signals.

In another variation of this embodiment, the first set of matrices is a group of n×n invertible matrices with a determinant of 1 and the second set of matrices is a group of n×n diagonal, invertible matrices with a determinant of 1.

In yet another variation of this embodiment, the plurality of linear groups has a number of linear groups equal to a number of modes in the plurality of modes.

In another embodiment, a system for identifying and classifying multilinear data sets into a plurality of classes using invariant theory may be provided. The system includes: one or more processors; a memory; and a non-transitory computer-readable medium coupled to the one or more processors and the memory and storing instructions thereon that, when executed by the one or more processors, cause the computing device to: receive an input data set, wherein the input data set is a multilinear input data set and includes a plurality of modes, each mode representative of a different subset of the input data set; compute a change of coordinates for each mode of the plurality of modes for the input data set using an invariant theory optimization algorithm, wherein the computing includes: constructing a chosen group, wherein the chosen group is a direct product of a plurality of linear groups and each linear group is independently chosen from a first set of matrices or a second set of matrices, determining a group element in the chosen group, wherein the group element comprises at least one matrix corresponding to each respective mode of the plurality of modes such that a norm of the input data under a group action induced by the group element is a local minimum, and calculating the change of coordinates based on the at least one matrix corresponding to each respective mode; transform the input data set into a relocated data set by applying each change of coordinates for each respective mode of the plurality of modes for the input data set by multiplying the subset of the input data set for each mode by the at least one matrix corresponding to each respective mode; and classify, based on distances between coordinates in the relocated data set, the input data set into the plurality of classes.

In a variation of this embodiment, the non-transitory computer-readable medium further stores instructions that, when executed by the one or more processors, cause the computing device to further: receive training data for each class of the plurality of classes; and classify the input data set further based on the training data for each class of the plurality of classes.

In another variation of this embodiment, the chosen group is a product group G, and further wherein: the training data is

$${\{ 𝒳 {m}_{i} \}}_{i} {=}^{{N}_{m}} 1$$

for each class

$$𝒳 {m}_{m} {=}^{n} 1 ,$$

where n is the number of classes, χₘ_{ᵢ} is the ith entry in a set, and there are Nₘ entries in a set for χₘ; and dᵢ=∥(Aᵢ, Bᵢ, . . . , Ωᵢ)·(ζ−χ̅)∥, where ζ is the input data set, (Aᵢ, Bᵢ, . . . , Ωᵢ) is the group element of the product group G comprising the at least one matrix for each respective mode, and

$$\overline{χ} = \frac{1}{{N}_{m}} ( {\sum }_{i = 1}^{{N}_{m}} {χ}_{{m}_{i}} ) .$$

In yet another variation of this embodiment, ζ is classified as belonging to class k when dₖ=min(dᵢ).

In still yet another variation of this embodiment, the non-transitory computer-readable medium further stores instructions that, when executed by the one or more processors, cause the computing device to further: determine a similarity score for each class of the plurality of classes based on the training data; and classify the input data set further based on the similarity score for each class of the plurality of classes; wherein the similarity score is defined as

$${s}_{i} = 1 - \frac{{d}_{i}}{{\sum }_{j = 1}^{n} {d}_{j}} .$$

In a variation of this embodiment, determining the group element includes: iteratively fixing each matrix of the at least one matrix except one matrix of the at least one matrix; and determining the one matrix such that the norm of the input data under the group action is a local minimum when each other matrix is fixed.

In another variation of this embodiment, the iterative fixing and determining repeats until a change in local minimum is less than a predetermined tolerance value.

In yet another variation of this embodiment, the iterative fixing and determining repeats until a predetermined number of iterations have occurred.

In still yet another variation of this embodiment, the relocated data set has a same tensor rank as the input data set.

In a variation of this embodiment, each matrix of the at least one matrix is an invertible matrix with a determinant of 1.

In another variation of this embodiment, the invariant theory optimization algorithm is an algorithm in accordance with Kempf-Ness theory.

In yet another variation of this embodiment, the distances between coordinates are Mahalanobis distances.

In still yet another variation of this embodiment, the input data set is a tensor of electrocardiogram (ECG) signals and one or more features of the ECG signals are classified.

In a variation of this embodiment, the plurality of classes are determined based on at least one of: heartbeat classification, T-wave alternans detection, and/or changes in heartbeat morphology.

In another variation of this embodiment, the input data set comprises either of: canonical polyadic decomposition (CPD) based data or higher order singular value decomposition (HOSVD) based data.

In yet another variation of this embodiment, the input data set is data in a format of at least one of: video data, facial recognition data, hyper-spectral image data, multi-lead signal data, and/or higher-order statistic data.

In still yet another variation of this embodiment, receiving the input data set includes: receiving raw data, and transforming the raw data into the input data set using a tensorization approximation.

In a variation of this embodiment, the raw data is a multi-lead ECG signal for a patient and wherein transforming the raw data into the input data set using a tensorization approximation includes: splitting the multi-lead ECG signal into one or more split signals; removing noise from the split signals using a filter; applying the tensorization approximation to each lead of the denoised signals using a predetermined number of fixed parameter values; extracting, after applying the tensorization approximation, a plurality of features from each lead; and outputting a tensor for each of the denoised signals.

In another variation of this embodiment, the first set of matrices is a group of n×n invertible matrices with a determinant of 1 and the second set of matrices is a group of n×n diagonal, invertible matrices with a determinant of 1.

In yet another variation of this embodiment, the plurality of linear groups has a number of linear groups equal to a number of modes in the plurality of modes.

### BRIEF DESCRIPTION OF THE DRAWINGS

FIG. 1 illustrates a diagram depicting an example system for receiving a multilinear data set and classifying the data set using invariant theory transformation;

FIG. 2 illustrates a diagram depicting two example functions that the system of FIG. 1 performs in various implementations, including a training function and a testing function;

FIG. 3 illustrates an example flowchart depicting an example method for constructing tensors from raw data to be analyzed by the system of FIG. 1 and/or via the method of FIG. 4;

FIG. 4 illustrates an example flowchart depicting an example method for receiving a multilinear data set and classifying the data set using invariant theory transformation, to be implemented in a system such as the system of FIG. 1.

### DETAILED DESCRIPTION

While current techniques such as Linear Discriminant Analysis (LDA) are able to analyze higher order data sets, such techniques are not optimized to do so and, as such, are slower and/or less accurate than may otherwise be the case. For example, techniques such as LDA require vectorization of data before analysis, which leads to (i) large vectors that are difficult to analyze and (ii) the loss of important information, like spatial locality. Moreover, vectorizing ignores the linear structure of the data set. For example, a matrix of rank one (i.e., a vector) depends on fewer parameters than a full rank matrix. Moreover, matrices from different classes might have different ranks, so techniques capable of properly taking linear structure into consideration may more accurately and/or more quickly analyze or classify data sets. Such considerations are even more prevalent for tensors and higher order data sets, such as images, electroencephalogram (EEG) data, and/or electrocardiogram (ECG) data.

As such, extending LDA to multilinear discriminant analysis (MDA) greatly improves the speed, quality, and accuracy of analyses and/or classifications of higher order data sets. LDA can be interpreted as finding the optimal projection to a lower dimensional space that maximizes distance between different classes (measured by a between-class scatter matrix) and minimizes distances within the same class (measured by a within-class scatter matrix). However, performing the same techniques for MDA and projecting tensor data to a lower dimensional vector or tensor space causes problems in the analysis due to the existence of local optima. Furthermore, the performance of such methods drastically depends on the choice of the dimensions of the space onto which the system projects. As the number of possibilities depends on the size of the tensor, increasing the size of the tensor rapidly increase the number of possibilities. For example, a 10×10×10 size tensor has 1000 possible dimensions onto which the system can project. As such, current techniques include an additional cost to time and resources of determining the optimal dimensions.

By using invariant theory, such as Kempf-Ness theory, and the Mahalanobis distance, the techniques disclosed herein can extend data analysis to higher order data sets. In some implementations, the systems and techniques disclosed herein use a k-means algorithm where the distance from the mean of the training data of each class is given by the Mahalanobis distance. In further implementations, the Mahalanobis distance of a point x from the mean of the training data x̅ is a Euclidean distance after a suitable change of coordinates, namely

$${\sum }^{\frac{- 1}{2}} ( x - \overline{x} ) ,$$

where Σ is a sample covariance matrix. For χ as a higher-order data set, applying a change of coordinates after vectorizing χ may alter the structure, causing problems with analysis, particularly where the data is sparse. The techniques described herein apply a different change of coordinates in each mode of χ (i.e., multiply by an invertible matrix in each mode), which preserves the rank. In some implementations, the techniques described herein further preserve the structure of the data by calculating and utilizing coordinate changes that preserve volumes, and therefore use invertible matrices with determinant 1.

The use of the techniques described herein disclosed herein is also useful in various applications, such as financial, security, and/or medical applications. For example, the techniques described herein can classify tensors extracted from ECG signals, which offers improved results in settings such as detection and localization of myocardial infarction, irregular heartbeat classification, ECG data compression, detection and quantification of T-wave alternans, and analysis of changes in heartbeat morphology. Similarly, the techniques described herein can classify tensors extracted from stock market data—offering improved results for brokerage and business performance analysis—as well as tensors extracted from computer networks—offering improved results for security testing and system performance analysis.

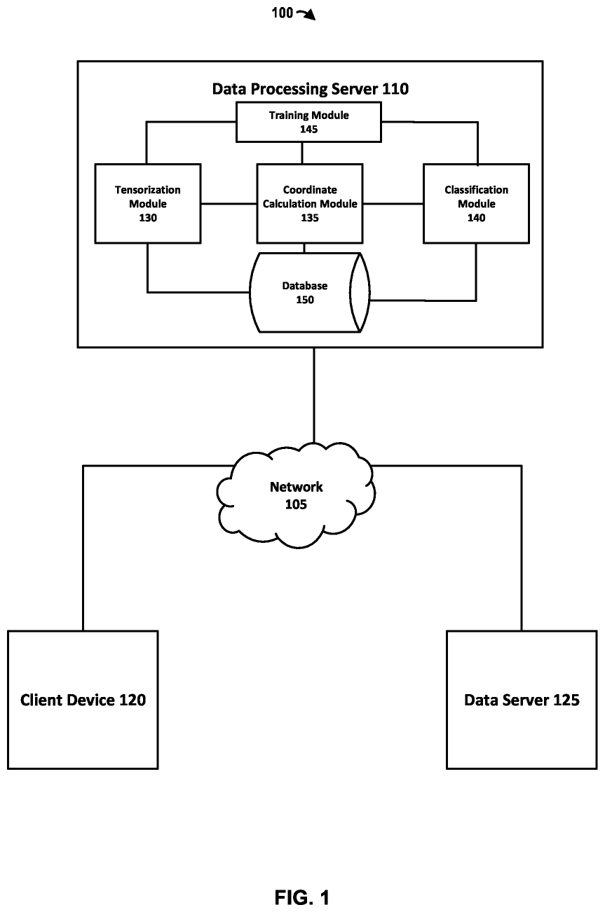

Referring first to FIG. 1, an example system for receiving a multilinear data set and classifying the data set using invariant theory transformation includes a network 105, a data processing server 110, and at least one of a client device 120 and/or a data server 125. The data processing server may additionally include a database 150 as well as various modules to process data, classify the data set, and/or train a machine learning model, such as tensorization module 130, coordinate calculation module 135, classification module 140, and/or training module 145.

The data processing server 110 includes at least one processor and a memory. The memory stores computer-executable instructions that, when executed by the processor, cause the processor to perform one or more of the operations described herein. The processors may include a variety of generic and/or specialized processors (or “processing devices”), such as microprocessors, application-specific integrated circuits (ASIC), digital signal processors, customized processors, field programmable gate arrays (FPGAs), or any combination thereof. Similarly, the memory may include a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, or any other suitable memory from which the processor can read instructions. The instructions can include code from any suitable programming language. Though not illustrated in FIG. 1, the data processing server 110 can include and/or is communicatively coupled to one or more computing devices or servers that can perform various functions.

The instructions stored in the memory of data processing server 110 may be instructions for implementing the various functionalities described herein for respective systems, as well as any data relating thereto, generated thereby, or received via any communications interface(s) and/or input device(s). In some implementations, the data processing server 110 includes the memory to store data structures and/or information related to, for example, software components of the data processing server 110 and/or algorithms used in training, testing, or utilizing models to tensorize raw data, calculate transformation coordinates in a Euclidean space, and classify input tensors and/or tensorial data as described in more detail below. In some such implementations, the memory includes or is part of the database 150. The processor(s) may execute instructions stored in the memory and, in so doing, may also read from and/or write to the memory various information processed and/or generated pursuant to execution of the instructions.

The processor(s) of the data processing server 110 also may be communicatively coupled to and/or control a communications interface of the data processing server 110 to transmit and/or receive various information pursuant to execution of instructions via the network 105. For example, the communications interface(s) may be coupled to a wired or wireless network, bus, and/or other communication means, and may therefore allow the data processing server 110 to transmit information to and/or receive information from other devices (e.g., other computer systems). Moreover, one or more communication interfaces facilitate information flow between the components of the data processing server 110. In some implementations, the communications interface(s) may be configured (e.g., via various hardware and/or software components) to provide a website and/or application to at least some aspects of the data processing server 110 as an access portal.

Further, the data processing server 110 may include output devices that, for example, allow a user to view and/or otherwise perceive various information in connection with the execution of the instructions. Similarly, the data processing server 110 may include input devices that, for example, allow a user to make manual adjustments, make selections, enter data, and/or interact in any of a variety of manners with the processor during execution of the instructions.

In some implementations, the network 105 can be and/or include any wireless or wired networks through which computing devices may communicate. For example, the network 105 may include the Internet, a local area network (LAN), a wide area network (WAN), a metropolitan area network, one or more intranets, an optical network, a cellular network, a satellite network, other types of data network, and/or a combination thereof.

The data processing server 110 is capable of communicating via the network 105 with the one or more client devices 120 and/or the data server 125. The network 105 can include any number of network devices, such as gateways, switches, routers, modems, repeaters, and wireless access points, among others. The network 105 can also include computing devices such as computer servers. The network 105 can further include any number of hardwired and/or wireless connections.

The one or more client devices 120 can include a computing device configured to acquire, display, and/or transmit data to be analyzed by the data processing server 110 as well as receive content (e.g., third-party content items such as texts, software programs, images, and/or videos) provided by the data processing server 110. The client device 120 can transmit and/or request and receive such content via the network 105. The client device 120 can include a desktop computer, laptop computer, tablet device, smartphone, personal digital assistant, mobile device, consumer computing device, server, digital video recorder, set-top box, smart television, or any other computing device capable of communicating via the network 105 and transmitting and/or receiving the data and/or analysis for data processing server 110. While FIG. 1 shows a single client device 120, it will be understood that the system 100 can include a plurality of client devices 120 served by the data processing server 110.

The data server 125 can include servers or other computing devices to provide raw data and/or tensorial data for the data processing server 110. The raw data and/or tensorial data can include video data, facial recognition data, hyper-spectral image data, multi-lead signal data, higher-order statistic data, canonical polyadic decomposition (CPD) based data, higher order singular value decomposition (HOSVD) based data, ECG signal data, financial signal data, security or network signal data, or any other such input data. In further implementations, the data server 125 can receive and store data such as tensorial data and/or tensor classifications from the data processing server 110.

The database 150 can maintain a data structure such as a table of virtual user identifiers, corresponding user identifiers and/or characteristics, and cookies associated with the virtual user identifiers. The database can further maintain one or more data structures regarding database and/or client device identifiers and/or information, such as a tree, a linked list, a table, a string, or a combination thereof.

The data processing server 110 further includes a number of logic modules. In some implementations, the data processing server 110 includes a tensorization module 130, a coordinate calculation module 135, a classification module 140, and/or a training module 145. Depending on the implementation, each of the tensorization module 130, coordinate calculation module 135, classification module 140, and/or training module 145 can be implemented as a software module, hardware module, or a combination of both. For example, each module can include a processing unit, server, virtual server, circuit, engine, agent, appliance, or other logic device such as programmable logic arrays configured to communicate with the database 150 and/or with other computing devices via the network 105. The computer-executable instructions stored in the memory of the data processing server 110 can include instructions which, when executed by one or more processors, cause the data processing server 110 to perform operations discussed below with regard to any of and/or any combination of the tensorization module 130, coordinate calculation module 135, classification module 140, and/or training module 145.

It will be understood that, although the present description generally uses 3-way tensors as examples, the techniques described herein may be applied to tensors of any size by properly expanding the techniques in question. Similarly, although the techniques described herein may explicitly describe a binary classification problem for simplicity, the techniques described herein may apply to any number of classes.

As a general example of such, the system 100 solves a binary classification problem (e.g., classified as “yes” or “no”, or any other similar binary operation) with training data given by 3-way tensors {χᵢ}ᵢ₌₁^{N}^{ᵢ} of size n₁×n₂×n₃ in class 1 and {γᵢ}ᵢ₌₁^{N}^{₂} of the same size in class 2. Given a new test tensor Z from one of class 1 or class 2, the data processing server 110 determines to which class the tensor Z belongs.

The tensorization module 130 receives input data from the system 100. In particular, the tensorization module 130 can receive input data from the database 150 and/or from either or both of the client device 120 and the data server 125 via the network 105. In some implementations, the tensorization module 130 receives input data already in the form of a tensor and determines to pass the data along to the coordinate calculation module 135 without modifying the tensor. In other implementations, the tensorization module 130 receives input data already in the form of a tensor and performs operations on the tensor before passing the data along to the coordinate calculation module 135. In yet other implementations, the tensorization module 130 receives raw data (e.g., data not in the form of a tensor), such as electrocardiogram (ECG) signal data, financial signal data, or any other such raw data.

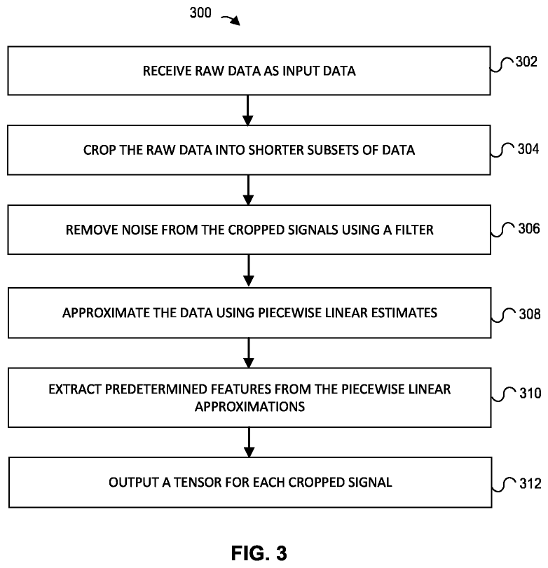

In some implementations, the tensorization module 130 translates the raw data to tensorial data. Depending on the implementation, the tensorization module 130 may translate the raw data by approximating the data using piecewise linear estimates and subsequently extracting features from the piecewise linear approximations. Using the extracted features, the tensorization module 130 then outputs tensors and/or tensorial data for the coordinate calculation module 135. In further implementations, the tensorization module 130 prepares the raw data by cropping the raw data into shorter subsets of data. In still further implementations, the tensorization module 130 removes noise from the cropped signals using a filter, such as a bandpass filter, a Butterworth filter, or a Chebyshev filter. The tensorization process is discussed with more detail in regard to FIG. 3, below.

The coordinate calculation module 135 receives input data in tensor form from the tensorization module 130. In some implementations in which the input data is already a tensor, the coordinate calculation module 135 instead receives the input data from the database 150 and/or from either or both of the client device 120 and the data server 125 via the network 105. In particular, the coordinate calculation module 135 uses the received tensor(s) and calculates coordinates in a classification space according to invariant theory to allow the classification module 140 to classify the tensor(s).

In some implementations, the coordinate calculation module 135 calculates the coordinates according to Kempf-Ness theorem. In particular, the coordinate calculation module 135 utilizes the guarantee from Kempf-Ness theorem that, if there is a critical point in the G-orbit of a group G, then the critical point is a minimum and is essentially unique. As such, there is a minimum element to which the elements of a tensor x can be moved by the elements of the group G. In particular, the coordinate calculation module 135 determines matrices (A₁, B₁, C₁)ϵG such that Σᵢ₌₁^{N}^{₁}∥(A₁, B₁, C₁)·(χᵢ−χ̅)∥² is minimal for the first class (where χ̅ is the mean of the tensors in the first class), and similarly for matrices (A₂, B₂, C₂) for the second class. According to Kempf-Ness theory, the coordinate calculation module 135 can simplify the problem to finding the minimum of the norm over the orbit K·T, wherein T is a 4-way tensor obtained by concatenating along the fourth mode all centered tensors Xi and wherein K=H₁×H₂×H₃×I_{N}_{₁} and K is the group acting as H₁×H₂×H₃ on the first three modes, and trivially (via the identity matrix) on the fourth mode. According to Kempf-Ness theory, if there is a critical point, then K·T has a unique minimum. By adopting a suitable regularization technique, the coordinate calculation module 135 determines that a critical point exists and, as such, so does a unique minimum.

In some implementations, the coordinate calculation module 135 determines the solution to the above problem by iteratively keeping two of the three matrices fixed while computing the third one. In further implementations, the coordinate calculation module 135 flattens the tensor by juxtaposing slices in a chosen mode, and subsequently iteratively concatenates the flattenings along each mode to determine the critical point for multiple tensors simultaneously.

Depending on the implementation, the group G may be the product of special linear groups SLₙ or torus groups Tₙ, or some combination thereof. In some implementations, the coordinate calculation module 135 determines the critical points differently depending on whether the actions on columns of a matrix Xϵ [symbol] ^{n×m} are SL actions or T actions.

For example, when the actions are SL actions, then the coordinate calculation module 135 performs as follows. Xϵ [symbol] ^{n×m} has rank n with n<m. Similarly, X=UΣV^{t} is a singular value decomposition with U,VϵSOₙ and singular values σ₁, . . . , σₙ. Further, σ̅ is the geometric mean of the singular values. If

$$D := [ \begin{matrix}\frac{\partial }{{σ}_{1}} & & \\ & ⋱ & \\ & & \frac{\partial }{{σ}_{n}}\end{matrix} ]$$

and A:=DU^{t}, then AX is a critical point for the norm function and is therefore a minimum point per Kempf-Ness theory. In particular, if the vectors x₁, . . . , xₘ ϵ [symbol] ⁿ are concatenated as columns of X and have mean zero, then XX^{t}=mΣ, and therefore

$$A {A}^{t} = {det ( X {X}^{t} )}^{\frac{1}{n}} {( X {X}^{t} )}^{- 1} = {det ( m \sum )}^{\frac{1}{n}} {( m \sum )}^{- 1} ,$$

so that A produces the Mahalanobis distance Σ⁻¹. In some implementations, if X has rank less than n, the coordinate calculation module 135 first regularizes X by replacing the matrix with (X|ϵIₙ) for a chosen regularization parameter ϵ>0 (i.e., concatenating a multiple of the identity) to ensure that the rank is n before performing the operations as outlined above. In other implementations, the coordinate calculation module 135 regularizes X even when the rank is equal to n.

As another example, when the actions are T actions, then the coordinate calculation module 135 performs as follows. Xϵ [symbol] ^{n×m} with no zero rows and n>m. σ₁, . . . , σₙ are the norms of the rows of X, and σ̅ is the geometric mean of σ₁, . . . σₙ. If

$$A := [ \begin{matrix}\frac{\partial }{{σ}_{1}} & & \\ & ⋱ & \\ & & \frac{\partial }{{σ}_{n}}\end{matrix} ] ,$$

then AX is a critical point for the norm function, and therefore a minimum point. In particular, if the vectors x₁, . . . , xₘϵ [symbol] ⁿ are concatenated as columns of X and have mean zero, σᵢ equals the standard deviation of the ith row (which is the ith feature of the vector data). Therefore, multiplying by A amounts to normalizing the features so that they have common standard deviation.

Similarly to SL actions, in some implementations, the coordinate calculation module 135 regularizes X if X has a zero row. The coordinate calculation module 135 regularizes the matrix X by replacing X with (X|ϵ1^{t}) for some chosen ϵ>0, where 1=(1, . . . , 1) is a row vector with n entries equal to 1.

After the coordinate calculation module 135 determines any critical points, the coordinate calculation module 135 then runs an algorithm on each class as follows. In some implementations, for T as the 4-way tensor obtained by concatenating along the fourth mode all centered tensors χᵢ in class 1, and the matricizations of T as T₍₁₎, T₍₂₎, T₍₃₎ along the first, second, and third modes, respectively, the coordinate calculation module 135 iteratively fixes each matrix except one and minimizes the norm with respect to the unfixed matrix. For example, rather than solving

$${argmin}_{( A , B , C )} ( {\sum }_{i = 1}^{{N}_{1}} {‖ ( A , B , C ) \cdot {χ}_{i} ‖}^{2} ) ,$$

the coordinate calculation module 135 fixes B and C before solving

$${argmin}_{A} ( {\sum }_{i = 1}^{{N}_{1}} {‖ ( A , B , C ) \cdot {χ}_{i} ‖}^{2} ) ,$$

which is equivalent to

$${argmin}_{A} ( {‖ ( A , B , C ) \cdot {T}_{( 1 )} ‖}^{2} ) ,$$

using any existing critical points as previously determined by the coordinate calculation module 135. Similarly, the coordinate calculation module 135 then fixes A and C before solving

$${argmin}_{B} ( {\sum }_{i = 1}^{{N}_{1}} {‖ ( A , B , C ) \cdot {χ}_{i} ‖}^{2} ) ,$$

which is equivalent to

$${argmin}_{B} ( {‖ ( A , B , C ) \cdot {T}_{( 2 )} ‖}^{2} ) .$$

The coordinate calculation module 135 then fixes A and B before solving

$${argmin}_{C} ( {\sum }_{i = 1}^{{N}_{1}} {‖ ( A , B , C ) \cdot {χ}_{i} ‖}^{2} ) ,$$

which is equivalent to

$${argmin}_{C} ( {‖ ( A , B , C ) \cdot {T}_{( 3 )} ‖}^{2} ) .$$

Depending on the implementation, the coordinate calculation module 135 then iteratively continues solving until each minimization is reducing the norm beyond a given tolerance level or until reaching a maximum chosen number of iterations.

As an example, the coordinate calculation module 135 receives centered training data {χᵢ}ᵢ₌₁^{N} from one class, with the ultimate output to be a change f coordinates (A, B, C)ϵH₁×H₂×H₃. For each i=1, . . . , N, the coordinate calculation module 135 determines T=cat(4,χᵢ). For initial minimums, the coordinate calculation module 135 sets min₁=∥T₍₁₎∥, min₁=∥T₍₂₎∥, and min₁=∥T₍₃₎∥. Then, while

$$\frac{{min}_{i} - new {Min}_{i}}{{min}_{i}} > tol$$

for i=1, 2, 3 and while the number of iterations is less than a predetermined maximum, the coordinate calculation module 135 iteratively determines

$${A}^{′} = {argmin}_{A} ( ‖ A \cdot {T}_{( 1 )} ‖ ) and {T}^{′} = {A}^{′} \times T , {B}^{′} = {argmin}_{B} ( ‖ B \cdot {T}_{( 2 )} ‖ )$$

### and T′=B′×T, and

$${C}^{′} = {argmin}_{C} ( ‖ C \cdot {T}_{( 3 )} ‖ ) and {T}^{′} = {C}^{′} \times T ,$$

wherein newMinᵢ=∥T′∥ for the relevant T′.

In some implementations, the classification module 140 then applies a k-means algorithm to compute distances d₁ and d₂ from the means of the two classes in the new coordinates. In some implementations, the classification module 140 determines similarity scores s₁ and s₂ between 0 and 1, each of which represents how close the input tensor is to each class, by defining

$${s}_{i} = 1 - ( \frac{{d}_{i}}{{d}_{1} + {d}_{2}} ) .$$

Depending on the implementation, the classification module 140 may classify an input tensor and/or input tensor data based directly on the distances or the similarity score.

In some implementations, the classification module 140 classifies the data when one distance is smaller than the other distance. For example, when d₁<d₂, the classification module 140 classifies the data as belonging to class 1. In further implementations, the classification module 140 classifies the data when one similarity score is greater than the other. For example, when s₁>s₂, the classification module 140 classifies the data as belonging to class 1. In still further implementations, the classification module 140 only classifies the data when a similarity score or distance surpasses a predetermined threshold. For example, if some set of data is greater than the distance threshold for both class 1 and 2, then the system 100 discards the data as not belonging to either class.

As an example, the classification module 140 receives training data {χᵢ}ᵢ₌₁^{N}^{₁},{γⱼ}ⱼ₌₁^{N}^{₂} from two classes. The classification module 140 further receives a tensor to classify, Z, to a class (e.g., the output). The classification module determines the averages of the sets of training data as

$$\overline{𝒳} = \frac{1}{{N}_{1}} ( {\sum }_{i = 1}^{{N}_{1}} 𝒳 i ) and \overline{γ} = \frac{1}{{N}_{2}} ( {\sum }_{j = 1}^{{N}_{2}} {𝒳}_{j} ) .$$

Then, using the new sets of coordinates for each class (A₁, B₁, C₁), (A₂, B₂, C₂)ϵH₁×H₂×H₃ calculated by the coordinate calculation module 135 (e.g., via the above example). The classification module 140 then calculates the distances from the two classes d₁=∥(A₁, B₁, C₁)·(Z−χ̅ ∥ and d₂=∥(A₂, B₂, C₂)·(Z−γ̅)∥. If d₁<d₂, then the tensor is closer to class 1 and the classification module 140 classifies the tensor appropriately. Similarly, if d₁>d₂, then the tensor is closer to class 2.

In some implementations, the system 100 performs the module functions as outlined above using one or more algorithms and/or a neural network. To train the algorithms and/or neural network, the training module 145 uses training data to improve the functionality of the modules as implemented above. In particular, in some implementations, the training module 145 trains the algorithms and/or neural network using a supervised machine learning program or algorithm. In further implementations, the training module 145 trains the algorithms and/or neural networks using an unsupervised machine learning program or algorithm. The neural network may be a convolutional neural network, a deep learning neural network, or a combined learning module or program that learns in two or more features or feature datasets (e.g., determining the coordinates and classification for input data) in a particular area of interest. The machine learning programs or algorithms may also include natural language processing, semantic analysis, automatic reasoning, regression analysis, support vector machine (SVM) analysis, decision tree analysis, random forest analysis, k-Nearest neighbor analysis, naïve Bayes analysis, clustering, reinforcement learning, and/or other machine learning algorithms and/or techniques. In some embodiments, the machine learning based algorithms may be included as a library or package executed on a computing platform (e.g., user computing device 102). For example, libraries may include the TENSORFLOW based library, the PYTORCH library, and/or the SCIKIT-LEARN Python library.

Machine learning may involve identifying and recognizing patterns in existing data (such as training a neural network based on labeled classes and training data) in order to facilitate making predictions or identification for subsequent data (such as using the neural network on new tensorial data in order to determine in which class each tensor of the tensorial data belongs and/or most closely aligns).

The training module 145 may create and/or train machine learning model(s) implemented on the neural network(s), such as the tensorization module 130, coordinate calculation module 135, and classification module 140, described herein for some embodiments, based upon example data inputs or data (e.g., “training data” and related raw or tensorial data) in order to make valid and reliable predictions for new inputs, such as testing level or production level data or inputs. In supervised machine learning, a machine learning program operating as a neural network on a server, computing device, or other processor(s), may be provided with example inputs (e.g., “features” and/or “labels”) and their associated, or observed, outputs (e.g., “labels”) in order for the machine learning program or algorithm in the neural network to determine or discover rules, relationships, patterns, or otherwise machine learning “models” that map such inputs (e.g., “features”) to the outputs (e.g., “labels”), for example, by determining and/or assigning weights or other metrics to the model across its various feature categories. The training module may then provide such rules, relationships, or other models subsequent inputs in order for the neural network, executing on the server, computing device, or other processor(s), to predict, based on the discovered rules, relationships, or model, an expected output.

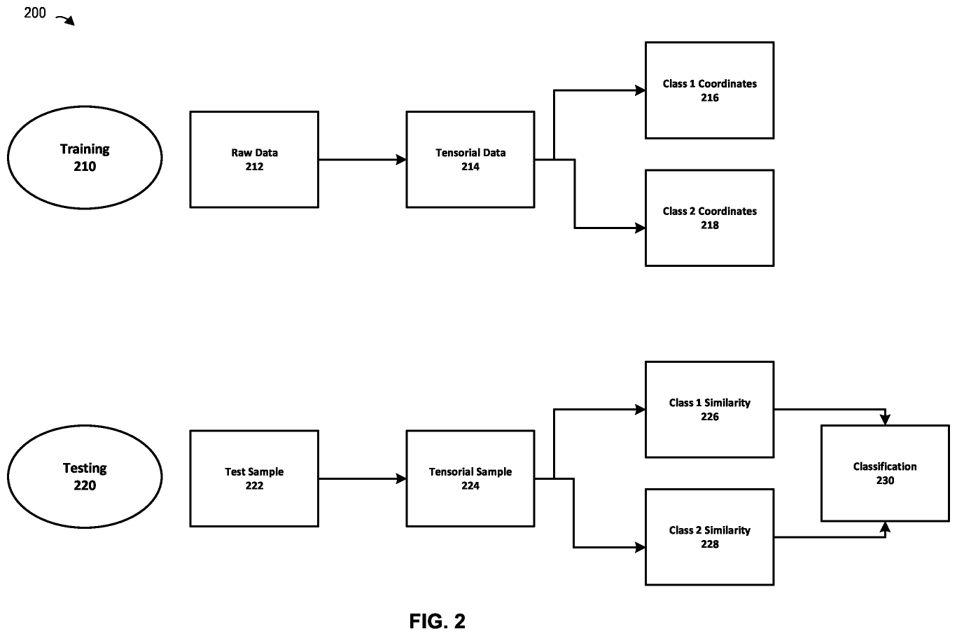

Referring next to FIG. 2, a diagram 200 illustrates two example functions that the system 100 performs in various implementations. In particular, diagram 200 illustrates a training function 210 and a testing function 220. Although the functions below are described with regard to the system 100 and various components thereof, it will be understood that reference to system 100 is for exemplary purposes only. Other similar such arrangements of modules and components as described herein may similarly perform the functions as described below.

In the training function 210, the system 100 receives raw data 212 as an input to the system 100, such as electrocardiogram (ECG) signal data, financial signal data, or any other such raw data. In some implementations, after receiving the raw data 212, the system 100 performs a tensorization function to translate the raw data 212 into tensorial data 214. Depending on the implementation, the tensorization function may be a Taut-string approximation or any other similar methodology for tensorization, as described in more detail with regard to FIG. 3 below. In some implementations, rather than receive raw data 212 and translate the raw data 212 into tensorial data 214, the system 100 instead receives tensorial data 214 outright. Similarly, depending on the implementation, the input data may be formatted as video data, facial recognition data, hyper-spectral image data, multi-lead signal data, electrocardiogram (ECG) signal data, and/or any other form of higher-order statistic data. In further implementations, the input data set includes either of canonical polyadic decomposition (CPD) based data or higher order singular value decomposition (HOSVD) based data.

After receiving or translating to the tensorial data 214, the system 100 determines class 1 coordinates and/or class 2 coordinates 218 from the tensorial data 214 as described in more detail with regard to FIG. 1, above. It will be understood that, although the description herein refers to two classes, the system 100 may determine any suitable number of classes using the techniques described herein, properly expanded. For example, rather than 2 classes, the system 100 may, depending on the implementation, determine coordinates for 3 classes, 5 classes, 10 classes, 100 classes, etc., based on the tensorial data at the cost of increased runtime and/or resources, accordingly.

In some implementations, after determining the class 1 coordinates 216 and class 2 coordinates 218, the training module 145 uses the raw data 212, the tensorial data 214, and the coordinates 216 and 218 to train the tensorization module 130 and the coordinate calculation module 135. In some such implementations, the raw data 212 and/or tensorial data 214 is training data and is labelled appropriately for the training module 145 to train the system 100.

The second function depicted by the diagram 200 is the testing function 220. Although the diagram 200 refers to the function as the “testing” function 220, it will be understood that the testing function 220 may similarly be used to evaluate real world or non-test data in addition to predetermined test data.

In the testing function 220, the system 100 receives a test sample 222 as input data. In some implementations, the test sample 222 is raw data similar to raw data 212 and the testing function 220 causes the tensorization module 130 to perform a tensorization function as described above to translate the test sample 222 into a tensorial sample 224. In other implementations, the system 100 receives the tensorial sample 224 outright and does not translate a test sample 222 including raw data into a tensorial sample 224.

In some implementations, after determining and/or receiving the tensorial sample 224, the coordinate calculation module 135 and/or classification module 140 use the tensorial sample 224 and the previously trained class 1 coordinates 216 and class 2 coordinates 218 to determine the similarity of each entry in the tensorial sample 224 to each of class 1 and class 2. As such, the system 100 determines the class 1 similarity 226 and/or the class 2 similarity 228 of each entry in the tensorial sample 224 according to the distance, such as the Mahalanobis distance, from the class 1 coordinates 216 and class 2 coordinates 218.

The function 222 then causes the classification module 140 to determine a classification 230 for each entry in the tensorial sample 224. In some implementations, the classification module 140 determines the classification 230 based on whether the class 1 similarity 226 or the class 2 similarity 228 is greater. In other implementations, the classification module 140 determines the classification 230 based on whether one of the class 1 similarity 226 or the class 2 similarity 228 is greater than a predetermined threshold value. In some such implementations, the classification module 140 discards any entries in the tensorial sample 224 where both the class 1 similarity 226 and the class 2 similarity 228 are below the predetermined threshold value. As such, the classification module 140 determines a classification 230 for data sufficiently close to one of the two classes while disregarding data that is unlikely to be either. In some further implementations, the classification module 140 may classify some entries of the tensorial sample 224 as belonging to both class 1 and class 2 based on the class 1 similarity 226 and the class 2 similarity 228.

Referring next to FIG. 3, a flowchart illustrates an example method 300 for constructing tensors from raw data to be analyzed by system 100 and/or via method 400 as described herein. The method of FIG. 3 may be implemented in a system 100 as described with regard to FIG. 1 above. Though the method below is described with regard to system 100, it will be recognized that any similarly suitable system may be used to implement method 300.

At block 302, the data processing server 110 receives raw data as input data. In some implementations, the raw data may be ECG signals for a patient with a varying number of leads. Depending on the implementation, the raw data may include any of physiological signal data (e.g., ECG data, EEG data, PPG data, etc.), financial signal data, security or network signal data, or any other such input data and/or combination as described herein.

At block 304, the data processing server 110 crops the raw data into shorter subsets of data. In some implementations in which the raw data is and/or includes multi-lead or disparate signals, such as ECG signals, the data processing server 110 crops the signals into multiple signals of a predetermined length. In further implementations, the data processing server can create multiple cropped signals from the multi-lead signals. In other implementations, the data processing server crops a single signal from each multi-lead signal. Then, at block 306, the data processing system removes noise from the cropped signals using a filter, such as a bandpass filter, a Butterworth filter, a Chebyshev filter, or any other appropriate filter.

At block 308, the data processing server 110 approximates the raw data using piece-wise linear estimates. In some implementations, the data processing server 110 uses a Taut String Method (also referred to as Taut-string) to construct the piece-wise linear approximation. In an example such implementation, the data processing server 110 receives multi-lead signals with peaks at time r₀, . . . rₙ. As such, the lengths between the peaks are computed as z=D(r)=(r₁−r₀, . . . , rₙ−rₙ₋₁), where D: [symbol] → [symbol] ⁿ⁻¹ is the difference operator. For a fixed ϵ>0, x=TS(z, ϵ) is a unique (Taut-string) function such that ∥z−x∥_{∞}≤ϵ and ∥D(x)∥₂ is minimized. Further, z=x+y where x is a denoised, smoother approximation of z, and y is the noise with ∥y∥_{∞}≤ϵ. As such, by varying ϵ, the data processing server 110 is able to consider different scales and multiple approximations of one signal at the same time, and therefore to extract higher order features (e.g., a matrix of features from a single signal).

At block 310, the data processing server 110 extracts predetermined features from the piecewise linear approximations. In implementations in which the raw data is a multi-lead signal, the data processing server 110 extracts the features from each lead. For example, the data processing server can extract features such as mean, standard deviation, skewness, kurtosis, etc. from each lead. At block 312, the data processing server 110 then outputs a tensor for each cropped signal. In some implementations, the tensor is of size x×y×z, where x is the number of features, y is the number of fixed parameters, and z is the number of leads in the multi-lead signal.

As an example, the data processing server 110 receives 12 lead ECG signals for one patient as input data. The data processing server 110 then splits each 12 lead ECG signal into one or more signals 90 seconds long before removing noise from each split signal using a Butterworth filter. The data processing server 110 then applies the Taut String Method to each lead with 5 fixed parameter values to extract 6 features from each lead. Then, the data processing server 110 outputs a tensor of size 6×5×12 for each 90 second long signal.

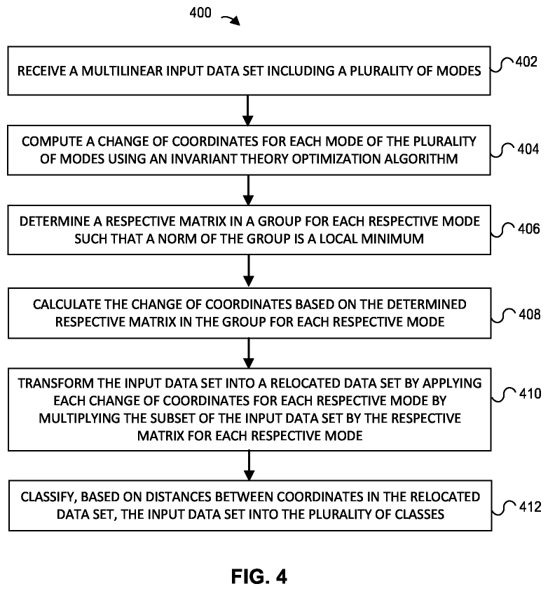

Referring next to FIG. 4, a flowchart illustrates a method 400 for receiving a multilinear data set and classifying the data set using invariant theory transformation. The method of FIG. 4 may be implemented in a system 100 as described with regard to FIG. 1 above. Though the method below is described with regard to system 100, it will be recognized that any similarly suitable system may be used to implement method 400.

At block 402, the data processing server 110 receives an input data set. In some implementations, the input data set is a multilinear data set and includes a plurality of modes, each mode representative of a different subset of the input data. In further implementations, the multilinear data set is a tensor and therefore has a tensor rank. Depending on the implementation, the multilinear data set is data formatted as video data, facial recognition data, hyper-spectral image data, multi-lead signal data, electrocardiogram (ECG) signal data, and/or any other form of higher-order statistic data. Similarly, in further implementations, the input data set includes either of canonical polyadic decomposition (CPD) based data or higher order singular value decomposition (HOSVD) based data. In some such implementations, the multilinear data set is a tensor before the data processing server 110 receives the data. In other implementations, however, the data processing server 110 instead receives raw data and transforms the raw data into the input data set using a tensorization approximation.

For example, the raw data can be a multi-lead electrocardiogram (ECG) signal for a patient. In such an example, the data processing server 110 splits the multi-lead ECG signal into one or more split signals. The data processing server 110 then removes noise from the split signals using a filter before applying the tensorization approximation to each lead of the denoised signals using a predetermined number of fixed parameter values. Depending on the implementation, the filter is a bandpass filter, a Butterworth filter, a Chebyshev filter, etc. Similarly, the tensorization approximation may be a Taut-string approximation or any other similar methodology for tensorization. The data processing server 110 then extracts features from each lead and outputs a tensor for each denoised signal. In some implementation, each tensor may be of a size dependent on the multi-lead signal, the length of the split signals, the number of fixed parameter values, and/or the number of extracted features. For example, in an implementation in which the ECG signal is a 12-lead signal, the split signals are 90 seconds long, the tensorization approximation uses 5 fixed parameter values, and the data processing server 110 extracts 6 features from each lead, then the output may be a tensor of size 6×5×12 for each 90 second long signal.

The data processing server 110 then begins computing a change of coordinates for each mode of the plurality of modes for the input data set. In some implementations, the data processing server 110 performs the computation using an invariant theory optimization algorithm, such as an algorithm determined via and/or in accordance with Kempf-Ness theory.

In particular, at block 404 the data processing system 110 constructs a chosen group, wherein the group is a direct product of a plurality of linear groups, and each linear group is independently chosen from a first set of matrices or a second set of matrices. In some implementations, the first set of matrices is a copy of SLₙ, the special linear group of n×n invertible matrices with determinant 1. In further implementations, the second set of matrices is Tₙ, the group of n×n diagonal, invertible matrices with determinant 1. In other implementations, the first and/or second set of matrices is any mix of SLₙ and/or Tₙ groups. Depending on the implementation, the data processing system 110 and/or a user of the data processing system 110 may determine the number of linear groups such that the number of linear groups is equal to the number of modes within the input data.

At block 406, the data processing server 110 determines a group element in the chosen group, wherein the group element comprises at least one matrix corresponding to each respective mode of the plurality of modes such that a norm of the input data under a group action induced by the group element is a local minimum. Depending on the implementation, each matrix of the at least one matrix may be an invertible matrix with a determinant of 1 to improve ease and/or processing speed in determining the matrices. In some implementations, determining the at least one matrix for each respective mode includes iteratively fixing each matrix except one matrix and determining the one matrix such that a norm of the input data under the group action is a local minimum when each other matrix is fixed. Depending on the implementation, the iterative fixing and determining repeats until (i) a change in local minimum is less than a predetermined tolerance value or (ii) a predetermined number of iterations have occurred.

At block 408, the data processing server 110 calculates the change of coordinates based on the at least one matrix corresponding to each respective mode. Although FIG. 4 depicts blocks 406 and 408 as occurring after block 404, depending on the implementation, either or both of blocks 406 and 408 may occur as part of block 404. For example, the data processing server 110 may determine a group element and/or calculate the change of coordinates based on the determined respective matrix as described above as part of constructing the chosen group, and may iteratively correct and/or improve the group, group elements, and/or change of coordinates after constructing the initial group.

At block 410, the data processing server 110 transforms the input data set into a relocated data set. In some implementations, the data processing server 110 performs the transformation by applying each change of coordinates for each respective mode of the plurality of modes for the input data set by multiplying the subset of the input data set for each mode by the at least one matrix corresponding to each respective mode.

At block 412, the data processing server 110 classifies, based on distances between coordinates in the relocated data set, such as Mahalanobis distances, the input data set into the plurality of classes. In some implementations, the data processing server 110 further receives training data for each class of the plurality of classes and performs the classification based on the training data for each class of the plurality of classes. In some such implementations, the training data is defined as

$${\{ 𝒳 {m}_{i} \}}_{i} {=}^{{N}_{m}} 1$$

for each class

$$𝒳 {m}_{m} {=}^{n} 1 ,$$

where n is the number of classes, χₘ_{ᵢ} is the ith entry in a set, and there are Nₘ entries in a set for χₘ. Further, dᵢ=∥(Aᵢ, Bᵢ, . . . , Ωᵢ)·(ζ−χ̅)∥, where ζ is the input data set, (Aᵢ, Bᵢ, Ωᵢ) is an element of the product group G comprised of respective matrices for each respective mode, and

$$\overline{𝒳} = \frac{1}{{N}_{m}} ( {\sum }_{i = 1}^{{N}_{m}} 𝒳 {m}_{i} )$$

and the input data set belongs to a class k when dₖ=min(dᵢ). Depending on the implementation, the data processing server 110 determines a similarity score for each class of the plurality of classes based on the training data and classifies the input data set further based on the similarity score for each class of the plurality of classes. In some such implementations, the similarity score is defined as

$${s}_{i} = 1 - \frac{{d}_{i}}{{\sum }_{j = 1}^{n} {d}_{j}} .$$

Depending on the implementation, the classes may be general or specific to the type of input data. For example, for medical data, the classes may be based on at least one of heartbeat classification, T-wave alternans detection, and/or changes in heartbeat morphology. As such, the classes may be “healthy” or “unhealthy” when referring to a patient. Similarly, in financial applications the classes may be “profit” and “loss” and, in security applications, the classes may be “safe” and “vulnerable”. In some implementations, the classes may include a runoff or “miscellaneous” category to classify any variables as input that do not match the remainder of the data and is therefore “junk” data.

As an example, the system 100 can receive tensorial data obtained from tensors χᵢ with a unique CP decomposition. As such, the CP decomposition of each tensor χᵢ keeps a diagonal core and χᵢ=Σⱼ₌₁^{r}σⱼaⱼ∘bⱼ∘cⱼ=[σ₁, . . . σᵣ; A, B, C], with A=[a₁, . . . , aᵣ], B=[b₁, . . . , bᵣ], and C=[c₁, . . . , cᵣ] as factor matrices of χᵢ. In the example, for class 1, the tensorial data 214 has rank r₁ and each matrix A, B, C has r₁ columns and random normal entries. The noise in each matrix A, B, C can be represented by ηEₖ, where Eₖ is a matrix with random normal entries), and the overall noise in the tensor χᵢ is ρMⁱ, where Mⁱ is a tensor with random normal entries. The tensors for class 1, then, are χᵢ=[A+ηE₁ⁱ, B+ηE₂ⁱ, C+ηE₃ⁱ]+ρMⁱ Similarly, in the example, for class 2, the tensorial data similarly has a rank r₂, factor matrices F, G, H similar in property to A, B, C, and γᵢ=[F+ηE₁ⁱ, G+ηE₂ⁱ, H+ηE₃ⁱ]+ρMⁱ. Using the new sets of coordinates χᵢ and γᵢ, the system 100 can then determine the distance of an input tensor Z from each set of coordinates and, based on the distances, assign Z to a class.

As another example, the system 100 can receive HOSVD based tensorial data; In the example, the system 100 uses two distinct cores G₁ and G₂ of size 3×3×3 with standard normal random entries for two classes, as well as matrices U₁, U₂, U₃, V₁, V₂, V₃ of size 10×3 with orthogonal columns. The tensors χᵢ and γᵢ are represented by χᵢ=U₁×₁ U₂×₂ U₃×₃ (σG₁+ηNᵢ)+25(V₁×₁ V₂×₂ V₃×₃ ϵᵢ) and γᵢ=U₁×₁ U₂×₂ U₃×₃ (σG₂+ηNᵢ)+25(V₁×₁ V₂×₂ V₃×₃ ϵᵢ), where Nᵢ and εᵢ are tensors of size 3×3×3 with standard normal random entries, representing noise in the entries.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

Moreover, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality and improve the functioning of conventional computers.

What is claimed is:

1. A method for identifying and classifying multilinear data sets into a plurality of classes using invariant theory, the method comprising:
receiving, by one or more processors, an input data set, wherein the input data set is a multilinear input data set and includes a plurality of modes, each mode representative of a different subset of the input data set;
computing, by the one or more processors, a change of coordinates for each mode of the plurality of modes for the input data set using an invariant theory optimization algorithm, wherein the computing includes:
constructing a chosen group, wherein the group is a direct product of a plurality of linear groups and each linear group is independently chosen from a first set of matrices or a second set of matrices;
determining a group element in the chosen group, wherein the group element comprises at least one matrix corresponding to each respective mode of the plurality of modes such that a norm of the input data under a group action induced by the group element is a local minimum; and
calculating the change of coordinates based on the at least one matrix corresponding to each respective mode;
transforming, by the one or more processors, the input data set into a relocated data set by applying each change of coordinates for each respective mode of the plurality of modes for the input data set by multiplying the subset of the input data set for each mode by the at least one matrix corresponding to each respective mode; and
classifying, by the one or more processors and based on distances between coordinates in the relocated data set, the input data set into the plurality of classes.

2. The method of claim 1, further comprising:
receiving training data for each class of the plurality of classes; and
classifying the input data set further based on the training data for each class of the plurality of classes.

3. The method of claim 2, wherein the chosen group is a product group G, and further wherein:
the training data is
$${\{ 𝒳 {m}_{i} \}}_{i} {=}^{{N}_{m}} 1$$
for each class
$$𝒳 {m}_{m} {=}^{n} 1 ,$$
where n is the number of classes, χₘ_{ᵢ} is the ith entry in a set, and there are Nₘ entries in a set for χₘ; and
dᵢ=∥(Aᵢ, Bᵢ, . . . , Ωᵢ)·(ζ−χ̅)∥, where ζ is the input data set, (Aᵢ, Bᵢ, . . . , Ωᵢ) is the group element of the product group G, comprising the at least one matrix for each respective mode, and
$$\overline{𝒳} = \frac{1}{{N}_{m}} ( {\sum }_{i = 1}^{{N}_{m}} 𝒳 {m}_{i} ) .$$

4. The method of claim 3, further comprising:
determining a similarity score for each class of the plurality of classes based on the training data; and
classifying the input data set further based on the similarity score for each class of the plurality of classes;
wherein the similarity score is defined as
$${s}_{i} = 1 - \frac{{d}_{i}}{{\sum }_{j = 1}^{n} {d}_{j}} .$$

5. The method of claim 1, wherein determining the group element includes:
iteratively fixing each matrix of the at least one matrix except one matrix of the at least one matrix; and
determining the one matrix such that the norm of the input data under the group action is a local minimum when each other matrix is fixed.

6. The method of claim 1, wherein the input data set is a tensor of electrocardiogram (ECG) signals and one or more features of the ECG signals are classified.

7. The method of claim 1, wherein the input data set comprises either of: canonical polyadic decomposition (CPD) based data or higher order singular value decomposition (HOSVD) based data.

8. The method of claim 1, wherein the input data set is data in a format of at least one of: video data, facial recognition data, hyper-spectral image data, multi-lead signal data, and/or higher-order statistic data.

9. The method of claim 1, wherein receiving the input data set includes:
receiving raw data, and
transforming the raw data into the input data set using a tensorization approximation.

10. The method of claim 9, wherein the raw data is a multi-lead ECG signal for a patient and wherein transforming the raw data into the input data set using a tensorization approximation includes:
splitting the multi-lead ECG signal into one or more split signals;
removing noise from the split signals using a filter;
applying the tensorization approximation to each lead of the denoised signals using a predetermined number of fixed parameter values;
extracting, after applying the tensorization approximation, a plurality of features from each lead; and
outputting a tensor for each of the denoised signals.

11. A system for identifying and classifying multilinear data sets into a plurality of classes using invariant theory, the system comprising:
one or more processors;
a memory; and
a non-transitory computer-readable medium coupled to the one or more processors and the memory and storing instructions thereon that, when executed by the one or more processors, cause the computing device to:
receive an input data set, wherein the input data set is a multilinear input data set and includes a plurality of modes, each mode representative of a different subset of the input data set;
compute a change of coordinates for each mode of the plurality of modes for the input data set using an invariant theory optimization algorithm, wherein the computing includes:
constructing a chosen group, wherein the chosen group is a direct product of a plurality of linear groups and each linear group is independently chosen from a first set of matrices or a second set of matrices,
determining a group element in the chosen group, wherein the group element comprises at least one matrix corresponding to each respective mode of the plurality of modes such that a norm of the input data under a group action induced by the group element is a local minimum, and
calculating the change of coordinates based on the at least one matrix corresponding to each respective mode;
transform the input data set into a relocated data set by applying each change of coordinates for each respective mode of the plurality of modes for the input data set by multiplying the subset of the input data set for each mode by the at least one matrix corresponding to each respective mode; and
classify, based on distances between coordinates in the relocated data set, the input data set into the plurality of classes.

12. The system of claim 11, wherein the non-transitory computer-readable medium further stores instructions that, when executed by the one or more processors, cause the computing device to further:
receive training data for each class of the plurality of classes; and
classify the input data set further based on the training data for each class of the plurality of classes.

13. The system of claim 12, wherein the chosen group is a product group G, and further wherein:
the training data is
$${\{ 𝒳 {m}_{i} \}}_{i} {=}^{{N}_{m}} 1$$
for each class
$$𝒳 {m}_{m} {=}^{n} 1 ,$$
where n is the number of classes, χₘ_{ᵢ} is the ith entry in a set, and there are Nₘ entries in a set for χₘ; and
dᵢ=∥(Aᵢ, Bᵢ, . . . , Ωᵢ)∥, where ζ is the input data set, (Aᵢ, Bᵢ, . . . , Ωᵢ) is the group element of the product group G comprising the at least one matrix for each respective mode, and
$$\overline{𝒳} = \frac{1}{{N}_{m}} ( {\sum }_{i = 1}^{{N}_{m}} 𝒳 {m}_{i} ) .$$

14. The system of claim 13, wherein the non-transitory computer-readable medium further stores instructions that, when executed by the one or more processors, cause the computing device to further:
determine a similarity score for each class of the plurality of classes based on the training data; and
classify the input data set further based on the similarity score for each class of the plurality of classes;
wherein the similarity score is defined as
$${s}_{i} = 1 - \frac{{d}_{i}}{{\sum }_{j = 1}^{n} {d}_{j}} .$$

15. The system of claim 11, wherein determining the group element includes:
iteratively fixing each matrix of the at least one matrix except one matrix of the at least one matrix; and
determining the one matrix such that the norm of the input data under the group action is a local minimum when each other matrix is fixed.

16. The system of claim 11, wherein the input data set is a tensor of electrocardiogram (ECG) signals and one or more features of the ECG signals are classified.

17. The system of claim 11, wherein the input data set comprises either of: canonical polyadic decomposition (CPD) based data or higher order singular value decomposition (HOSVD) based data.

18. The system of claim 11, wherein the input data set is data in a format of at least one of: video data, facial recognition data, hyper-spectral image data, multi-lead signal data, and/or higher-order statistic data.

19. The system of claim 11, wherein receiving the input data set includes:
receiving raw data, and
transforming the raw data into the input data set using a tensorization approximation.

20. The system of claim 19, wherein the raw data is a multi-lead ECG signal for a patient and wherein transforming the raw data into the input data set using a tensorization approximation includes:
splitting the multi-lead ECG signal into one or more split signals;
removing noise from the split signals using a filter;
applying the tensorization approximation to each lead of the denoised signals using a predetermined number of fixed parameter values;
extracting, after applying the tensorization approximation, a plurality of features from each lead; and
outputting a tensor for each of the denoised signals.
